(19) United States
(12) Patent Application Publication
(10) Pub. No.: US 2012/0111189 A1
(43) Pub. Date: May 10, 2012

(54) METHOD AND SYSTEM FOR GAS CAPTURE

(75) Inventors: Svein Knudsen, Lovenstad (NO); Norbert Schmidbauer, Fetsund (NO)

(73) Assignee: NORSK INSTITUTT FOR LUFTFORSKNING, Kjeller (NO)

(21) Appl. No.: 13/255,372

(22) PCT Filed: Mar. 9, 2010
(86) PCT No.: PCT/NO2010/000093

§ 371 Date: Jan. 19, 2012

Related U.S. Application Data
(60) Provisional application No. 61/158,593, filed on Mar. 9, 2009.

(30) Foreign Application Priority Data
Jul. 31, 2009 (NO) 20092793

(51) Int. Cl. B01D 53/14

(52) U.S. Cl. 95/8; 95/156; 95/172; 95/46; 95/185; 95/154; 95/159; 96/181; 96/175

(57) ABSTRACT

Method and system to capture target gases from all kind of point-sources, as well as from ambient air and surface waters, sediments or soils by advantage of large differences in Henrys law constants. For gas dissolution in water the constants favor dissolution of e.g. CO₂ compared to the main constituents of flue gases like N₂ and O₂. The main principle is to dissolve the gases—release of the non-dissolved part stripping the liquid for the dissolved gases, which are enriched in target gas. Further steps can be used to reach a predetermined level of target gas concentration.

### FIELD OF THE INVENTION

The present invention relates to the field of gas capture.

### BACKGROUND OF THE INVENTION

Effective CO₂ capture and sequestering is a main challenge for coming generations in order to reduce man-made global warming. Use of Hydrogen as a main energy source/carrier in a future society is widely discussed. The use of Methanol as a far superior (safety, storage) and also renewable energy carrier is suggested by Nobel Laureate George Olah in Beyond Oil and Gas: The Methanol Economy (Wiley 2006). A prerequisite for a carbon neutral Methanol Economy is that the CO₂ used for the production of the Methanol is captured from the air or from biomass. The hydrogen and the energy used for the production of Methanol could in a transition phase also derive from fossil fuels as long as the CO₂ produced in that process is sequestered.

There are several industrial processes developed or under development to capture CO₂ from flue gas. The most promising ones are using different aqueous solutions of alkanolamines, chilled ammonia or different hydroxide solutions to remove CO₂ by either absorption or chemical reaction. Releasing CO₂ from the absorbents for storage demands quite high amounts of energy making the CO₂ capture process expensive.

It is well known that CO₂ can be physically absorbed in liquid in accordance with Henry's law. In “Carbon capture and its storage: an integrated assessment”, edited by Simon Shackley and Clair Gough (Ashgate, 2006) the use of Henry's law is discussed related to FIG. 3.4 of the reference book, but the method is dismissed as cost prohibitive at low concentrations. At higher concentrations it is suggested not to use water, but a solvent.

The use of water under high pressure conditions has been used within the treatment of syn-gas production in ammonia-production plants (Kohl A. and Nielsen R.; Gas Purification. 5.ed. Gulf Publishing Company, Houston 1997).

There are obvious advantages by using water as absorbent-it is cheap, non-poisonous and does not add new compounds to the purified gas stream. There is little corrosion due the low temperatures used in the processes. Disadvantages are the relative low absorption load which is achievable—hence requiring a high amount of absorbent compared to other absorbents (like alkanol amines etc.). In industrial scrubbing processes—usually the gas is treated with a very thin absorption film on large surfaces. Other absorbents have usually lower surface tension resistance compared to water. Co-absorption of other gases like N₂ or O₂ in water is another disadvantage in industrial scrubber philosophy. In traditional gas purification using scrubbing towers aiming at purification of low CO₂ concentrations in large exhaust quantities, water is not the first choice of absorbent.

An overview of the state of the art is in the report “CO₂ Capture Project Phase 2—Status mid-2008” by Lars Ingolf Eide & al from the

http://www.co2captureproject.org.

This project study the following technologies:
Oxy-firing Fluidized Catalytic Cracker
Chemical Looping Combustion
Hydrogen Membrane Reformer
Membrane Water Gas Shift
Sorption Enhanced Water Gas Shift
Chemical Looping Reforming
One Step Decarbonisation
HyGenSys (Steam, Methane Reformer and Gas Turbine).

Carbon Capture in all these technologies have high cost performance in terms of yield and energy use, some use chemicals that can be problematic for the environment, such as amines, and they involve complicated, industrial processes.

There is a need for a simple and cost efficient method and system for gas capture, and in particular for capture of CO₂.

### SUMMARY OF THE INVENTION

The present invention is a method and a system for capturing and concentrating a target gas present in a flue gas mixture, or in the air.

The gas mixture is introduced into a liquid having higher solubility for the target gas than for other gases present in the gas mixture, then dissolved gases are released from the liquid, the released gases will constitute a new gas mixture This new gas mixture is introduced into a container comprising a liquid having higher solubility for the target gas than for other gases present in the new gas mixture, and then the steps are repeated until a concentration of the target gas in the new gas mixture is at a predetermined level in the liquid.

In this way it is possible to effectively capture for instance CO₂ from a power plant, by bubbling the flue gases through large amounts of water.

The composition of flue gases will include N₂, O₂ and CO₂, these gases have very different solubility in water.

Under normal atmospheric conditions and 25° C. ambient air contains about 79% N₂, 21% O₂ and 0.038% CO₂. One m³ of water in contact with an atmosphere like this will at equilibrium contain about 15 liter of dissolved gases with the following composition: 73% N₂, 25% O₂ and 1.7% CO₂. The dissolved gases are stripped out of the water, e.g by lowering the pressure and become a “new gas mixture” which is brought in contact with water in a second step. In this second step one m³ of water would then contain 27 liter of gas having the following composition: 36.6% N₂, 16% O₂ and 47,3% CO₂. In a third step as much as 360 liter of CO₂ would be solved compared to 5 liters of N₂ and about 3 liters of O₂.

One m³ of water effectively exposed to flue gas with 4% CO₂ will at equilibrium contain 45 liter of dissolved gases—the up-concentration of CO₂ within the first step is 15 fold to 66% CO₂.

Gas solubility is increasing with decreasing water temperature—at 4° C. the solubility of CO₂ in water is doubled compared to 25° C. Henrys law is valid for most gases up to several bar pressure. Hence the amount of dissolved gas in water doubles with an increase in pressure of 1 bar.

The main principle of the process is:
Effective contact between gas and water, such as by streaming bubbles or small bubbles created by cavitations improving the speed and efficiency of gas absorption, turbulence devices. In some of the applications spray absorption or large wetted surface areas could be applied in addition
Release of non-dissolved gas—this gas mixture could be used in further steps.
Stripping of the dissolved gases from the water, e.g. by lowering the partial pressure, use of sub-ambient pressure, use of ultra sonic devices and offering large surfaces like raschig rings or nano-surfaces or nano-particles. The speed of the out-gassing due to lowering the partial pressure will follow different rates. In the case of water exposed to air—N₂ will outgas faster than O₂ and O₂ faster than CO₂. This process can be utilized in order to enhance the target gas concentration further.

This process can be repeated in consecutive steps until a concentration is reached. The stripping process involves use of pressure difference and may also use ordinary industrial processes like ultrasonic, membranes, pressure exchanger or additives.

Some of the advantages of the present invention are:
Water is used in large quantities in low cost containers; this is a very simple process not aiming at the very high yields of purification (over 90%).
The heat of dissolution which is normally a problem in industrial scrubbing processes is easier to handle when the amount of gas is dissolved in a large quantity of absorbing agent.
The process can easily be scaled up and down in order to adjust to different requirements. Prefabrication of small units suitable for minor exhaust quantities can be put together to larger unite on a modular basis.
For CO₂ capture from biomass burning processes, each quantity of captured CO₂—regardless the efficiency of the process—is a positive contribution in terms of climate change mitigation.
CO₂ can be captured either directly from air or water (oceans, surface waters) or from flue gas from industrial processes such as large point sources, fossil fuel or biomass energy facilities, industries with major COO₂ emissions like: cement plants, refineries, natural gas processing, synthetic fuel plants and energy production with fossil fuel and hydrogen production plants. CO₂ can also be captured from large mobile vehicles such as ships or trucks. CO₂ produced in landfills, composting or fermentation processes can be captured either from the gas-phase or the effluent water. CO₂ can also be captured from ventilation-systems in road tunnels or buildings like parking garages or sky-scrapers.
CO₂ is used to describe the invention, however a person skilled in the art will realize that it can be used for all gases having similar Henry's law constants in liquids(water) as CO₂, relative to other gases in a gas mixture, such as air or flue gas (e.g. SO₂, N₂O and NO₂).
The liquid is water in most embodiments of the present invention. However other liquids could be used, including known scrubbing liquids, and water with additives, including sea water. The liquid may also be in form of a spray or aerosol.

### BRIEF DESCRIPTION OF THE DRAWINGS

FIG. 1: Schematic view of the process.

FIG. 2: Cylinder solution, where the flue gas is bubbled into Chamber 1 through a manifold or a cavity disc and rise through the chamber and taken out of the tank at the top.

FIG. 3: Loop solution submerged in water.

FIG. 4: The flue gas is pumped into the bottom of the chamber.

FIG. 5: A pump is circulating the liquid in a loop, the liquid is exposed to a membrane that let gasses through but not water.

FIGS. 6a and 6b: The system is a series of horizontal loop-chambers. The volume of the chambers is not shown in scale.

FIG. 7: The different solutions described in FIGS. 1-5 can be arranged in arrays that interact.

FIG. 8: Reinjection of flue gas where CO₂ is partly removed.

FIG. 9: The system where the velocity of the rising air bubbles is partly counter balanced by a downward stream.

FIG. 10: Staged stripping, used to separate the different gasses in the liquid in steps like a temperature distillation only using pressure instead of temperature.

### DETAILED DESCRIPTION

Henry's law can at constant temperature be written as

P=k_{H}*c

where p is the partial pressure of the solute, c is the concentration of the solute and k_{H} is a constant with the dimensions of pressure divided by concentration. The constant, known as the Henry's law constant, depends on the solute, the solvent and the temperature.

Some values (in L.atm/mol) for k_{H} for gases dissolved in water at 298 kelvin (25 C.) are:

O₂: 770

CO₂: 29

H₂: 1280

N₂: 1640

NO₂: 25 to 80

N₂O : 41

CH₄: 770

SO₂: 0.8

H₂S : 10

In a mixture of ideal gas Dalton's law of partial pressures applies, stating that “the total pressure exerted by a gaseous mixture is equal to the sum of the partial pressures of each individual component in a gas mixture”. This can be applied to air or flue gases.

Henry's law, using water as the liquid, says: “At a constant temperature, the amount of a given gas dissolved in a given type and volume of liquid is directly proportional to the partial pressure of that gas in equilibrium with that liquid.”

The Henry's Law constant for CO₂ is of one magnitude less than for the other gases in air or flue gas, and thus relatively more CO₂ than other gases will be dissolved in the water and hereby depleting the gas phase for CO₂

The majority of the CO₂ remains as dissolved molecules and only one out of 1000 CO₂ molecules is converted into carbonic acid, thus Henry's law applies even though strictly speaking it only applies for solutions where the solvent does not react chemically with the gas being dissolved. In the absence of a catalyst, the equilibrium is reached quite slowly. The rate constants are 0.039 s⁻¹ for the forward reaction (CO₂+H₂O→H₂CO₃) and 23 s⁻¹ for the reverse reaction (H₂CO₃→CO₂+H₂O).

The gas mixture from which the target gas will be captured can be either flue gas, air, outgases from surface waters (oceans, lakes, rivers) or even a land surface such as soil, landfills, composting/fermentation processes.

The flue gases from a gas power plant consist mainly of N₂, O₂ and water vapor, with up to 4% CO₂. When introduced to water there will after a certain time delay be a state of equilibrium between the gases and the liquid. The relative concentration of the gases in the gas mixture will change when they are dissolved in water, and at a lower temperature more gas can be dissolved. If the pressure is doubled, the amount of gas that can be dissolved is also doubled.

The mixing ratio of CO₂ in ambient air is 0.04%. The mixing ratio of CO₂ dissolved in water exposed to ambient air is 1.7% due to Henry's law. For a flue gas with a mixing ratio of 4% CO₂, the corresponding mixing ratio of CO₂ is 66%.

A prerequisite is that duration of contact between the gas mixture and the water is long enough, or the surface of contact large enough, for the gas to dissolve. A practical solution that increases the contact surface is to dissolve the gas as streams of bubbles. In general small bubbles ascend slower than larger, due to the kinematic viscosity of the fluid. The size of the bubbles will vary during the ascent as the gases are captured.

For bubbles with radius below 0.5 mm the speed is estimated by the formula:

V=⅓r²g/n

where r is the radius of the bubble, g is the acceleration of gravity and n is the kinematic viscosity of the fluid. For water 0.011 cm²/s.

Larger bubbles follow, because of interaction in the boundary layer between gases and fluid, the formula is:

v= 1/9r²g/n

When the bubbles are more than 0.5 cm in radius the bubbles are flattened and the viscosity does not matter much and the formula is:

v=⅔sqrt(g/R)

where R is the radius of curvature of the spherical top of the bubble. For such large bubbles, the relatively smaller ones rise faster.

The amount of gas that is captured is then determined by the size of the bubbles and the time they are in contact with the fluid; the above formula may then be used to estimate an ideal size for the bubbles.

The air or flue gas that reaches the top of the absorption chamber, can be released into the open air, into the sea, sent back to the combustion process, or sent to a new stage of the capture process.

In particular the CO₂ can be delivered both as a gas or as water containing the gas. This water may then be stored or used in industrial processes (pumped to deep sea deposits, oil wells or mineral carbonization processes).

Chemical additives can be used that change the surface tension of the liquid, ultrasonic equipment or selective membranes can be used to either enhance the dissolution process or the stripping process.

Subsea containers can be used, as the pressure here naturally will be higher and the temperature lower than at the surface or on land. It is also easier to create differences in pressure, and construction can benefit from the pressure outside and inside the container being fairly similar; a container can be made of a membrane and water can be circulated in a loop for CO₂ capture and release.

Aside from constructing containers, there could also be natural formations or water bodies, such as fjords, lakes, rivers, valleys or natural caverns, where the water loop could be placed or the water body by itself used as the first mixing chamber and then stripped into a decompression chamber.

The out—gassing can be initiated by simply reducing the partial pressure. There are also other methods for releasing a gas from a liquid, e.g. stirring or seeding with particles with a suitable surface—either by structure or chemical composition; venturi or cavitation chambers can also be used. Such methods use little energy compared with other methods for CO₂ capture.

A typical gas power plant (400 MW) will emit one million tons of CO₂ per year. The amount of exhaust is about 430 m³/s containing 4% CO₂—the amount of water to trap the CO₂ would be about 500 m³/s at 298 K and atmospheric pressure. This is similar to the flow of water in a large hydropower turbine. However, by reducing the temperature and increase the pressure, this volume of 500 m³/s could be reduced significantly.

A gas with higher solubility is easier to dissolve but also more difficult to release and vice versa. During both the dissolving process of gases with large difference in Henrys Law constants and the release process of those gases states of non-equilibrium could be used in order to favor the target gas.

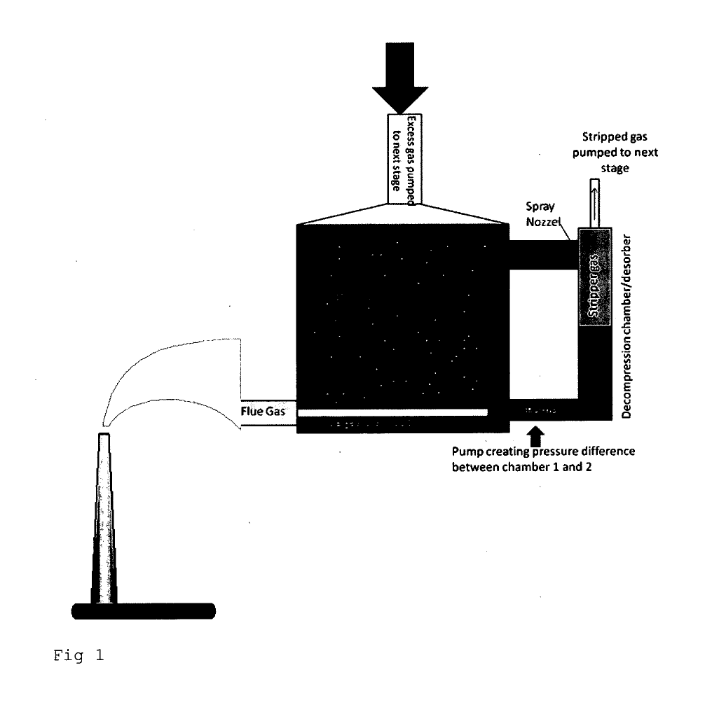

FIG. 1 shows a schematic view of the process, where flue gas is introduced into the dissolver chamber and the non dissolved gas is emitted to the atmosphere. The CO₂ enriched gas can be sent to storage or to further treatment. The gas stream can be ventilated to air, inserted into the air inlet for a combustion process or entered into a new concentration unit.

FIG. 2 shows an embodiment with a cylinder solution, where the flue gas is bubbled into Chamber 1 through a manifold or cavity disc and rise through the chamber and taken out of the tank at the top. The cavity disc can be similar to that described in patent application EP2125174A1 and sold by Ultrasonic Systems GmbH or from SU1240439A1. The liquid is taken out through a nozzle. The driving pressure is created by a pump, pumping liquid from chamber 2 into chamber 1 producing low pressure in Chamber 2 because of the restriction in nozzle(s) inserting the water into chamber 2. The stripped gas with enriched CO₂ is pumped for storage. If the content of CO₂ is not according to specification the gas can enter into a similar step that will increase further the concentration. This construction can be submerged in water but also be built on land.

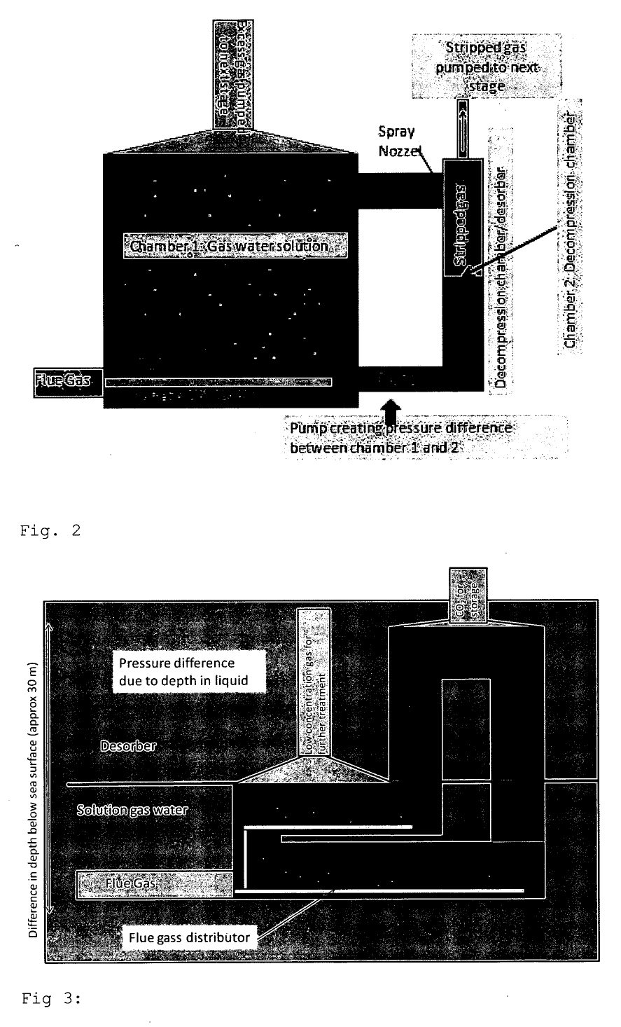

FIG. 3 shows another embodiment with a loop solution submerged in water. The liquid is flowing in a loop and the flue gas bubbled into the liquid at approximately 20-30 m depth. The loop must be made of a flexible substance so that the loop is inflated by a slight overpressure in the loop. The liquid is circulated. The loop have a desorber where the pressure is reduced by lifting the water close to the surface where the pressure is lower and the gas can be released and pumped out for storage or further treatment.

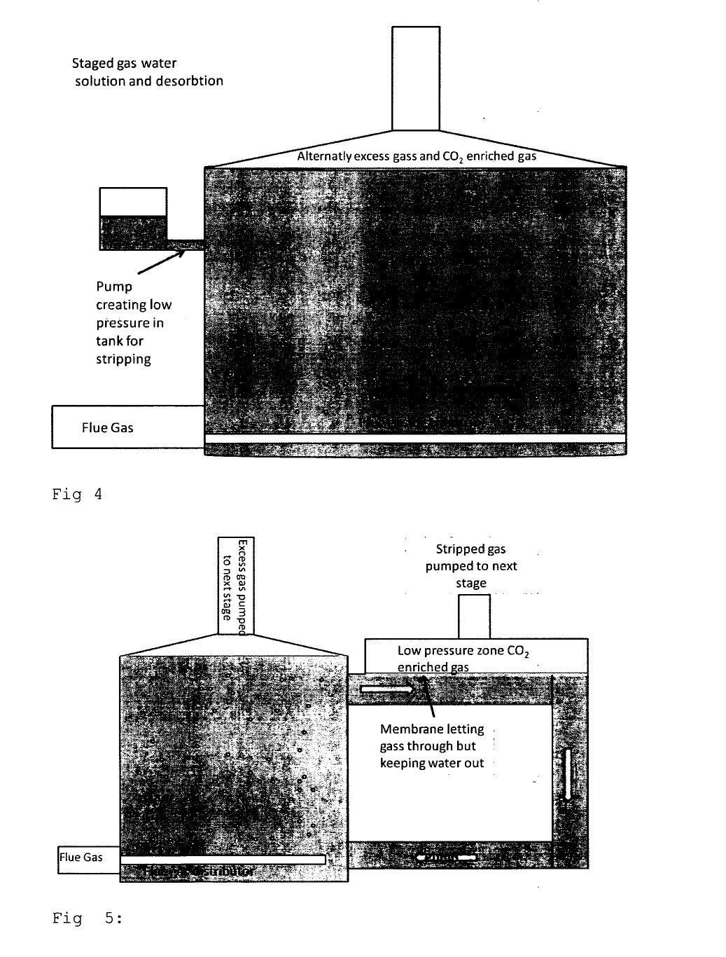

FIG. 4 shows the use of alternating pressure. The flue gas is pumped into the bottom of the chamber. The gas that is not absorbed can either go into a new step for further absorption or released to air. When the liquid reaches gas saturation the flue gas is shut off and a pump is used to reduce the pressure in the chamber and the dissolved gas is released. This gas can be pumped for storage or taken through a similar step for further improve the concentration. The process is then repeated.

FIG. 5 shows yet another embodiment where the process is similar to the process described in FIG. 1. The difference is that instead of entering the liquid into the low pressure zone a pump is circulating the liquid in a loop, the liquid is exposed to a membrane which is permeable to gases but not water. The gas phase is the low pressure side. The low pressure is maintained by a pump.

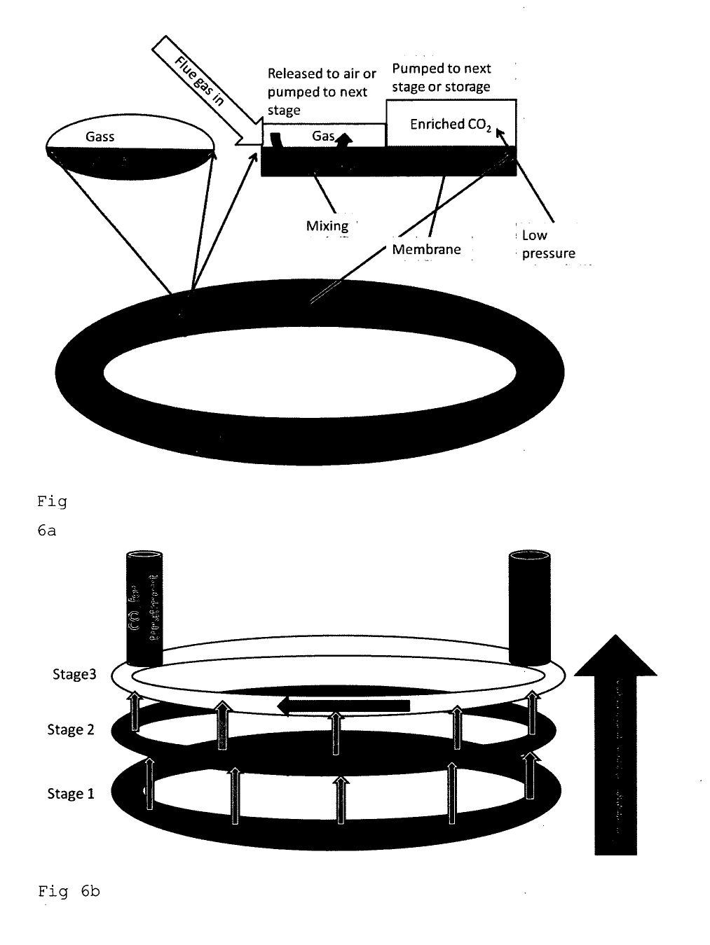

FIG. 6a shows a system with a series of chambers where one chamber is connected to the lower concentration chamber vertically as shown in FIG. 6b. The tube is half filled with liquid and half filled with flue gas, as shown in the cross section in FIG. 6a. The flue gas is mixed with the water. The water is in sections covered with a gas permeable membrane. The liquid flows around the loop. Above the membrane a low pressure is maintained. The flue gas is bubbled into the lower stage. The CO₂ will be sent to further treatment and the gas with a low CO₂ content emitted to air. The number of stacked chambers on top of each other is dependent on the targeted concentration of CO₂. The size of the chamber for stage two and three will be in the order of 10 to 50 times smaller because of the high solubility of the target gas and the resulting up-concentration ratios. (Note that in the figures the volume of the chambers are not shown in scale).

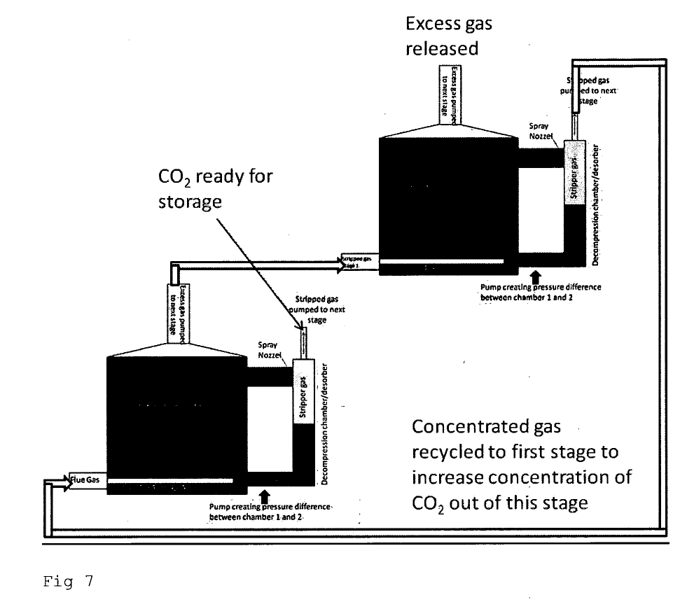

In FIG. 7 it is shown how different solutions described in FIGS. 1-6 can be arranged in arrays that interact to treat large volumes of gas and to reach a wanted concentration.

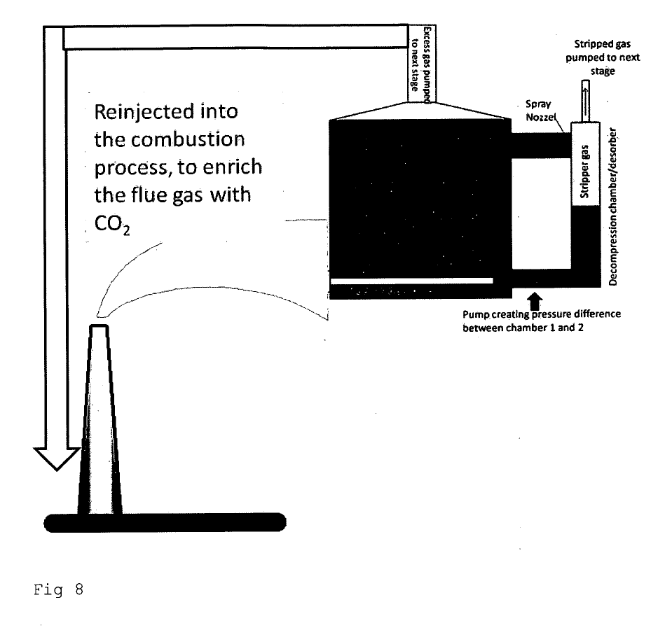

In FIG. 8 the flue gases from a coal power plant contain little or no N₂—while the CO₂ mixing ratios could be as much as 16%. Coal fired plants with oxygen often recycle the exhaust several times in order to utilize as much of the oxygen content as possible. A treatment of the flue gas in between the recycling could enhance the effect of such a plant since the exhaust from the treatment chamber would have diminished CO₂ values and enhanced O₂ levels.

In a preferred embodiment the system consist of a number of containers submerged in a natural water body or submerged in water reservoirs on land connected to form a multiple-stage process. The containers are fed with flue gases from a pipeline with typically 430 m³/s flue gas.

In another embodiment the system captures CO₂ from the air. It is possible to capture less efficient CO₂ in the initial stage, because the dimensions here are large and more costly, and instead increase capture more in later stages.

When capturing from air any exhaust from this process is unproblematic.

FIG. 9 shows a system where the velocity of the rising air bubbles is partly counter balanced by a downward stream in order to optimize the desired rate of dissolution and the size of the chamber. This is meant as a one-step system with release of the stripped exhaust gas direct to the air. This device could also serve as the last step for the final concentration of already pre-concentrated gas-mixtures (such as with CO2 concentrations higher than 10%) delivered from other systems mentioned before. The water is driven by a circulation pump with low energy consumption.

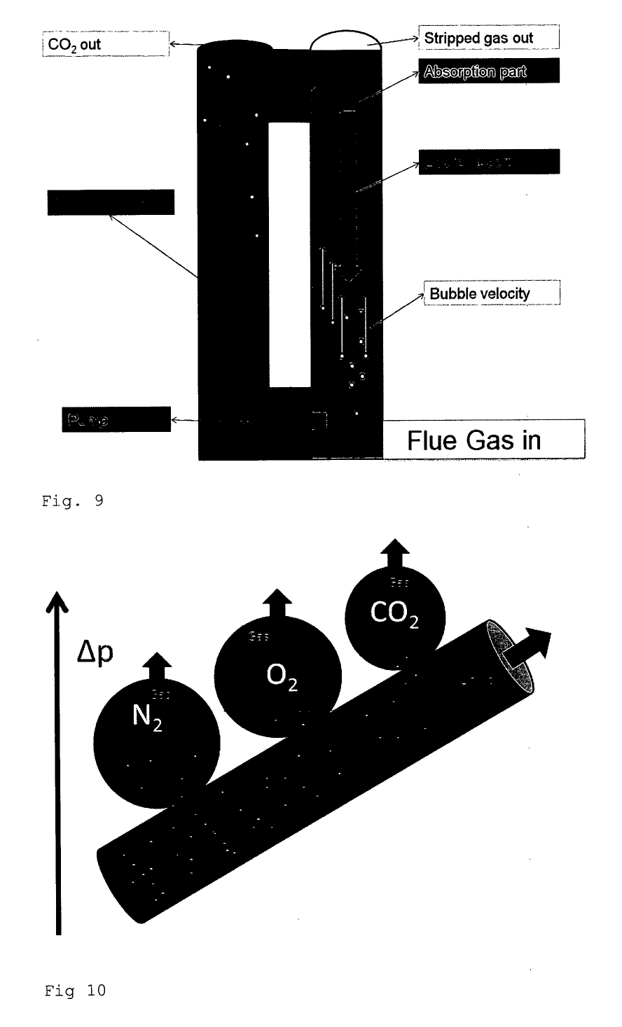

FIG. 10 shows staged stripping. Because of the difference in the solvability of the gases, the different gases will also create bubbles at different pressure and the gases can be taken out similar to a distillation with temperature, but instead use differences in pressure drop.

In yet another embodiment the system captures CO₂ already dissolved in sea water. This embodiment may include a system hydraulically operated using the force of the waves. A container having two pistons is filled with water and is submerged just below the surface. The wave forces are used to drive the uppermost piston and the second piston is pumping up deeper water, e.g. from 30 m, where the CO₂ concentration is around 1.5 g/m³. The water then circulates between the surface and the deep. With 1.5 million waves a year this is over 2 tonnes of CO₂ per m³ of pump volume, with a wave height of 1 m. (The average in the Norwegian Sea is 3 m). The gases are mainly stripped due to the difference in pressure, and can be sent to a next stage in the process. The cold water from the deep can be released at the surface and then bring surface water rich in CO₂ down to the bottom again. The air that has been stripped will have a higher O₂ content, almost twice that of ambient air. If this is used by a gas power plant, the combustion process will be much more efficient, and there are several other advantages in terms of flue gas composition.

In yet another embodiment the system is feeding exhaust gases from a power plant delivered by a pipeline to a offshore site. A wave powered hydraulic system is compressing and feeding the exhaust into a system as described in FIG. 9. A wave powered hydraulic system is also pumping the water in a counter stream to the gas-injection. An example of a renewable energy wave air pump is in U.S. Pat. No. 7,391,127 using wave energy to compress air. Such pumps are however designed to make renewable energy and not to catch CO₂ from exhaust

In yet another embodiment the entrance of a fjord is used, where the fjord is a natural reservoir and the differences in pressure across the entrance can be used.

Flue gases may also be led in pipes to a reservoir or a lake at a high altitude used for a hydro electric plant.

The water containing the captured gas is then fed into the pipes going down to the hydro turbine, where the CO₂ is released from the movement of the water hitting the turbine. The turbine could be placed at the top of the system, and thus the gas will bubble out in the pipes, and there could be one or more intermediate reservoirs creating several stages.

In two embodiments in particular useful for seagoing vessels, the flue gases containing approximately 13% CO₂, are fed into the a system of the present invention using one or more of
1. The ballast water tanks. This will combine CO₂ capture from its flue gases with reducing or killing microorganisms and algae.
2. The cargo and fuel tanks can be used for storage of captured CO₂, using it as a carpet over the hydrocarbons in replacement of today's nitrogen based systems.

Further NOx and particulate matter can be captured in the same system. A system onboard could also include production of methanol to fuel cells, or frozen CO₂ that could be used in the fishing industry or for other cooling purposes.

In another embodiment exhaust or flue gases are led into a chamber with a water layer with a thickness of some centimeters. The water layer is resting on a membrane, which could be made from Teflon or a specialized CO₂ selectively permeating membrane. The pressure is higher at the water side of the membrane, and CO₂ that is captured in the water then penetrates the membrane and is released in a second chamber below the membrane. This principle can also be used inside the pipes from the reservoir of a hydro electric plant or inside a construction placed in a river, tidal stream or using waves to change the pressure. Such constructions can be combined with biomass production, e.g. algeas or plants that use CO₂ in their growth cycle.

In an alternative embodiment the system uses one or more pipes with venturi for gas injection; then one or more large cavities where oxygen and nitrogen are released and removed. The principle here is to inject CO₂ under high pressure and remove the other gases at a lower pressure.

In an alternative embodiment the process is supplemented by using a liquid in form of an aerosol that is sprayed into the flue gases. The formation of the droplets can be controlled using nanoparticles, so that the droplets' core is a nanoparticle of a given shape. The aerosol can be used in open air or in a chimney. In the bottom of a chimney the pressure is lower than the outside air at the same altitude, so here the first step would be performed at a pressure below one atmosphere.

The alternative embodiments can be used in one or more stages of a capture process, and can be combined.

A small scale implementation of a module using the present invention has been set up, giving useful data. The rig is a vertical tube of approximately 10 cm in diameter and 10 m in height. The rig contains 75 liters of water. The rig is filled with water and can be opened in the bottom and top to create pressure or to maintain the pressure. There is an inlet in the bottom of the tube to insert gas. This is a device with 80 needle tips of laboratory syringes. These syringes have been fed with different types of gas with different concentration of CO₂. The gas that is inserted rises in the tube. While rising the bubbles increase in diameter due to pressure difference and collisions with other bubbles. The size of the bubble is deciding the rising velocity. Gas is absorbed into the water through the surface of the bubbles. The rising time for the bubbles in the water of the rig is between 30-40 s. When the bubbles reach the top, the gas can either be recycled or released to the atmosphere. When the gas has been exposed to the water for a sufficient time the absorption stage of the rig is ended.

The module shows that the gas is easily absorbed and an exposure of less than a minute reduces the CO₂ concentration considerably. The CO₂ gas is however more difficult to get out of the water—mainly due to the fact that the rig was not totally tight and pressure swings could not be performed.

Several ways to increase the speed of the out-gassing was implemented. The use of ultra sonic equipment showed that the theoretical amounts of gases that should have been dissolved in the water could be stripped out nearly quantitatively. The enrichment of CO₂ was verified—from initially 4% to more than 30% (which is then again the upper limit of the CO₂ measurements with Drager tubes that were used for measurements).

The speed of dissolution was about 15 liter of gas per second calculated for a 1 m2 area of injection. This figure could be improved to a more-fold number (using cavity disc injection)—but even this number scaled up to the 420 000 liter/s of exhaust from a gas power plant would not require more than an area of injection of about the area of 6 football-fields. This is comparable to the area of what a modern amine scrubber technology would require of space close to the exhaust pipe of the power plant. The reaction time of 30 seconds was with quite large bubble size (4 mm).

A gas containing 4% CO₂ was far below 1% after a contact time of about 1 minute. A shorter contact time is direct proportional to the total amount of water that has to be used as absorbent and thereby direct proportional to the size of the chambers.

1. Method for capturing and concentrating a target gas present in a flue gas mixture characterized by the steps of:
i) the gas mixture is introduced into a liquid having higher solubility for the target gas than for other gases present in the gas mixture,
ii) dissolved gases are released from the liquid, the released gases will constitute a new gas mixture
iii) said new gas mixture is introduced into a container comprising a liquid having higher solubility for the target gas than for other gases present in said new gas mixture,
said steps ii) and iii) are repeated until a concentration of the target gas in the new gas mixture is at a predetermined level in the liquid.

2. Method in accordance with claim 1, characterized by that the target gas is carbon dioxide.

3. Method in accordance with claim 1, characterized by that the target gas is released as the liquid is depressurized.

4. Method in accordance with claim 1, characterized by that the liquid is water, for example seawater, brackish water or fresh water.

5. Method in accordance with claim 1, characterized by that the pressure in at least one of the containers exceeds 2 atm.

6. Method according to claim 1, characterized by that at least one container is placed submerged under water.

7. Method in accordance with claim 1 characterized by that one or more of chemical additions, ultrasonic equipment, cavitation disc and selective membrane is used to enhance the dissolution process or the stripping process.

8. Method in accordance with claim 1 where other gases than the target gas are stripped in stages.

9. Method in accordance with claim 2, characterized by that the liquid having a predetermined level of target gas is delivered to a deep sea deposit.

10. Method in accordance with claim 2 where the carbon dioxide is captured from renewable sources and in a subsequent step is used to produce bio-fuel such as methanol.

11. Method for capturing and concentrating a target gas present in open air characterized by the steps of:
i) the air is introduced into a liquid having higher solubility for the target gas than for other gases present in the air,
ii) dissolved gases are released from the liquid, the released gases will constitute a new gas mixture
iii) said new gas mixture is introduced into a container comprising a liquid having higher solubility for the target gas than for other gases present in said new gas mixture,
said steps ii) and iii) are repeated until a concentration of the target gas in the new gas mixture is at a predetermined level in the liquid.

12. System for capturing and concentrating a target gas present in a flue gas mixture characterized by a number of containers comprising liquid having higher solubility for the target gas than for other gases present, the containers are arranged so that a gas mixture can be consequently fed into the containers, means for feeding the flue gas, means for releasing the gas mixture in the containers and means for transporting the released target gas.

13. System according to claim 12 with one or more of chemical additions to the liquid, use of ultrasonic equipment, cavitation discs or selective membranes.

14. System according to claim 12 where at least one container is placed submerged under water.

15. System according to claim 12 where the containers are one or more of ballast water tanks, cargo tanks or fuel tanks

16. System according to claim 12 where the liquid is water and the target gas is carbon dioxide.

17. (canceled)

18. (canceled)
